(19) United States
(12) Patent Application Publication
(10) Pub. No.: US 2011/0147248 A1
(43) Pub. Date: Jun. 23, 2011

(54) SHIPPING PLATFORM DISPLAY SYSTEM

(76) Inventors: Brandon M. D'Emidio, Orlando, FL (US); John Thomas Storteboom, Orlando, FL (US)

(21) Appl. No.: 12/974,178

(22) Filed: Dec. 21, 2010

Related U.S. Application Data
(60) Provisional application No. 61/288,448, filed on Dec. 21, 2009.

(51) Int. Cl. B65D 19/00; B23P 19/00

(52) U.S. Cl. 206/386; 29/428

(57) ABSTRACT

A shipping platform display system may include a covering material adjacent a shipping platform. The system may also include a first position where the covering material obstructs a side of the shipping platform to improve the shipping platform's appearance and/or relay information to an observer. The system may further include a second position where the covering material does not obstruct the side of the shipping platform to permit the shipping platform to be moved by a shipping platform mover.

### CROSS-REFERENCE TO RELATED APPLICATIONS

This application is based upon, and claims priority to, prior filed copending provisional application Ser. No.61/288,448 filed Dec. 21, 2009, the entire text of which is incorporated herein by reference.

### BACKGROUND

The invention relates to the field of shipping platforms, and, more particularly, to display systems for shipping platforms.

Many warehouse-type retailers such as Costco, Lowes, and/or the like, display merchandise to customers on the shipping platform, e.g. pallet, containers, and/or the like, on which the merchandise was shipped in and/or on. This technique, as illustrated in FIG. 1, reduces the retailer's cost related to the display of the merchandise by minimizing the handling of the displayed goods. As a result, the merchant may offer the goods at a lower cost than a tradition retailer.

### SUMMARY

According to one embodiment of the invention, a shipping platform display system may include a covering adjacent a shipping platform. The system may also include a first position where the covering obstructs a side of the shipping platform to improve the shipping platform's appearance for a consumer, the covering being non-destructively deployed in the first position. The system may further include a second position where the covering does not obstruct the side of the shipping platform to permit the shipping platform to be moved by a shipping platform mover, the covering being non-destructively stored in the second position in a smaller area than in the first position.

The covering may be carried by a shipping platform storage rack in which the shipping platform is positioned. The covering may be retractable into a housing carried by the shipping platform storage rack.

The housing may include a biasing mechanism that tensions the covering in the first position and returns the covering into the housing in the second position. The covering may carry a connector on the end opposite the biasing mechanism to engage the shipping platform storage rack. The housing may carry a second connector for engaging the shipping platform storage rack in a different area of the shipping platform storage rack than the first connector.

The covering may comprise a textile and/or a monolithic substance. The covering may comprise information carried by the covering that is directed to the consumer.

In an embodiment, the system may include a covering adjacent a shipping platform and carried by a shipping platform storage rack in which the shipping platform is positioned where the covering carries information that is directed to the consumer. The system may also include a first position where the covering obstructs a side of the shipping platform to improve the shipping platform's appearance and relay information to a consumer, the covering being non-destructively deployed in the first position. The system may further include a second position where the covering does not obstruct the side of the shipping platform to permit the shipping platform to be moved by a shipping platform mover, and the covering being non-destructively stored in the second position in a smaller area than in the first position.

Another aspect of the invention is a method for a shipping platform display system. The method may include sizing a covering to substantially visually obstruct a side of a shipping platform that faces a consumer in a retail location. The method may also include positioning the covering adjacent the side of the shipping platform to improve the appearance of the side for the consumer's benefit where the covering being non-destructively deployed in a first position. The method may further include moving the covering to permit the shipping platform to be moved by a shipping platform mover with the covering being non-destructively stored in a second position in a smaller area than in the first position.

The method may additionally include providing information on the covering material that is directed to the consumer. The moving may be done without tools, damage to the covering material, and/or permanent deformation to the covering material.

The method may also include providing a biasing mechanism in the housing that tensions the covering in the first position and returns the covering into the housing in the second position. The method may further include engaging a shipping platform storage rack with a connector on the covering end opposite the biasing mechanism in the first position. The method may further include engaging the shipping platform storage rack with a second connector in a different area of the shipping platform storage rack than the first connector.

### BRIEF DESCRIPTION OF THE DRAWINGS

FIG. 1 illustrates shipping platforms as displayed in the prior art.

FIGS. 2-4 illustrate a shipping platform display system in accordance with the invention.

FIG. 5 is a flowchart illustrating method aspects according to the invention.

FIG. 6 is a flowchart illustrating method aspects according to the method of FIG. 5.

FIG. 7 is a flowchart illustrating method aspects according to the method of FIG. 5.

FIG. 8 is a flowchart illustrating method aspects according to the method of FIG. 5.

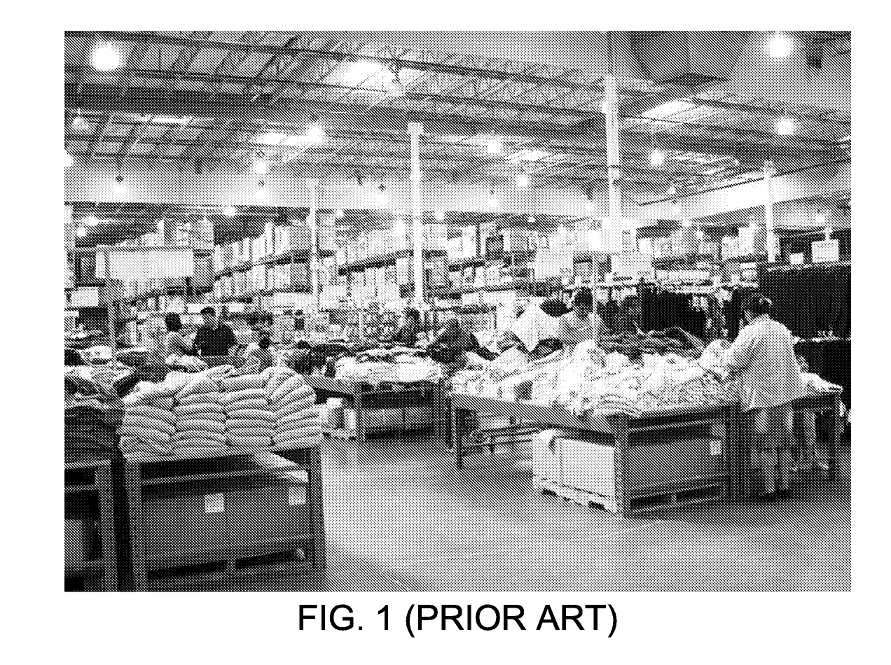

### DETAILED DESCRIPTION

The invention will now be described more fully hereinafter with reference to the accompanying drawings, in which preferred embodiments of the invention are shown. Like numbers refer to like elements throughout, like numbers with letter suffixes are used to identify similar parts in a single embodiment, and letter suffix lower case n is a variable that indicates an unlimited number of similar elements.

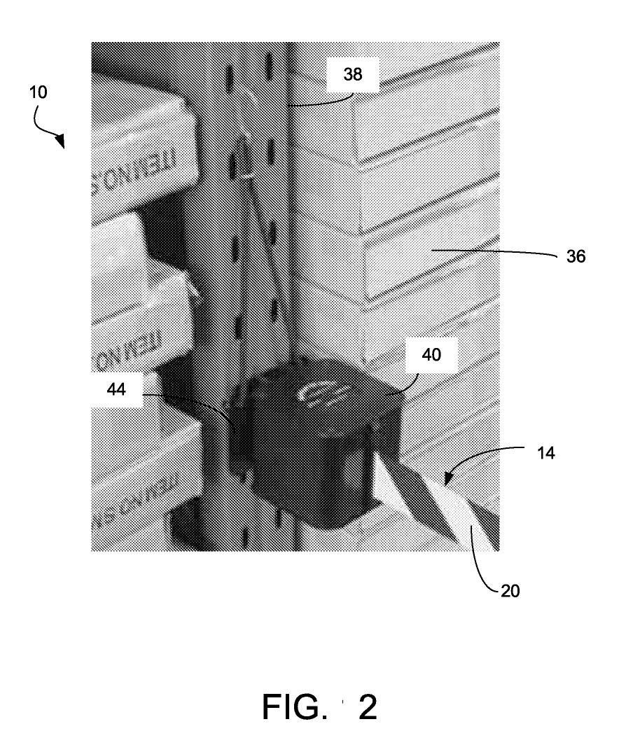

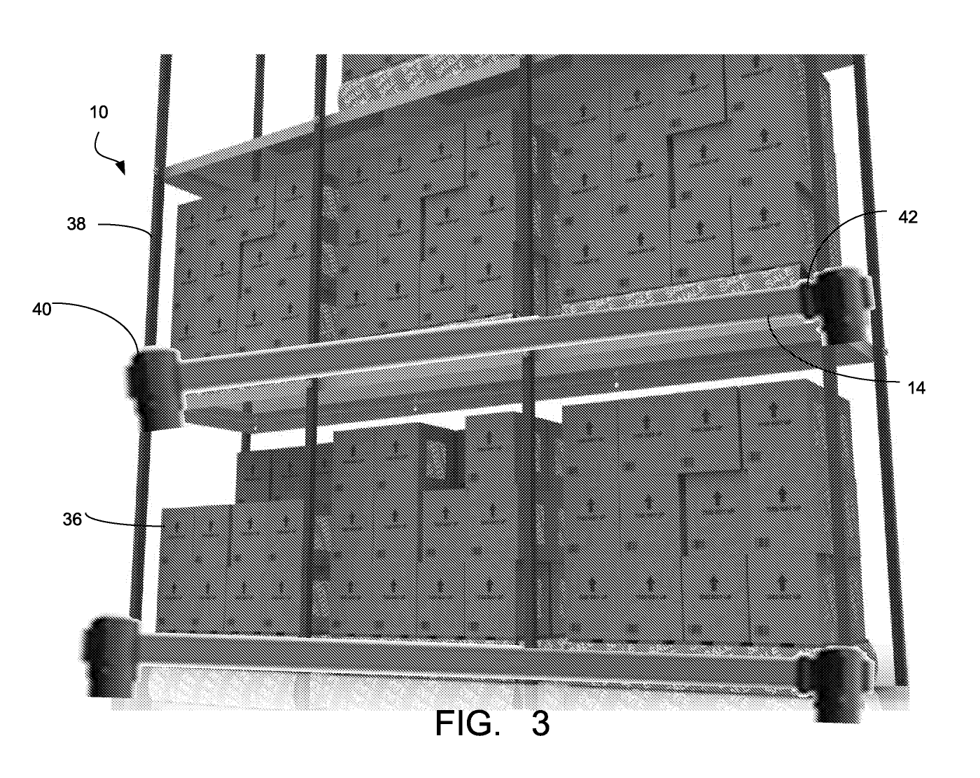

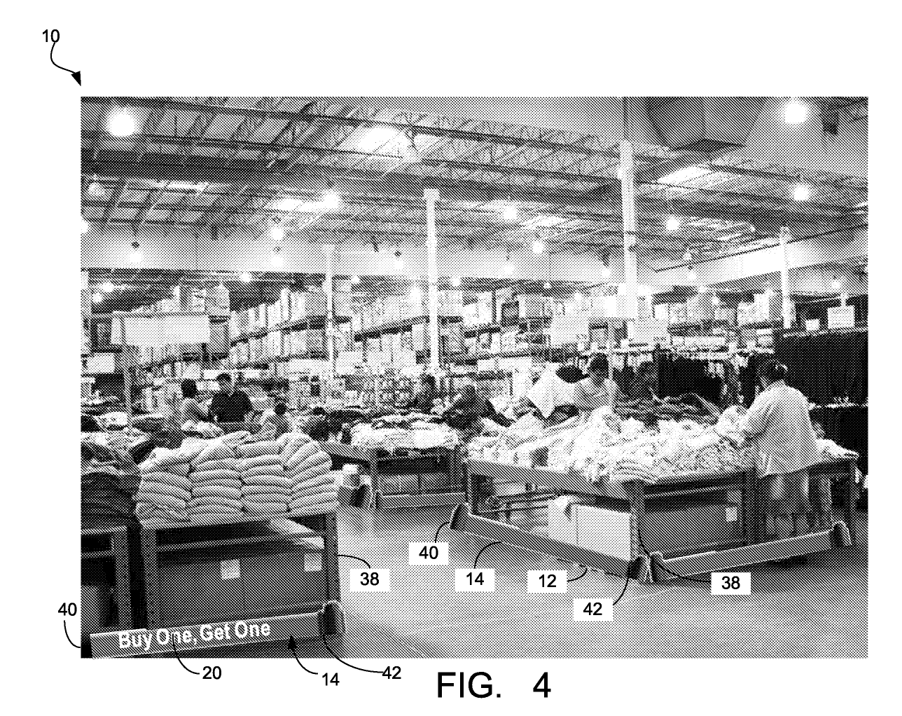

With reference now to FIGS. 2-4, a shipping platform 12 display system 10 is initially described. In an embodiment, the system 10 includes a covering 14 adjacent the shipping platform 12. The system 10 also includes a first position (see FIGS. 3 and 4) where the covering 14 obstructs a side 18 of the shipping platform 12 to improve the shipping platform's appearance and/or relay information 20, e.g. sale information, to a consumer (not shown). The covering 14 is non-destructively deployed in the first position 16.

The system 10 further includes a second position (see FIG. 2) where the covering 14 does not obstruct the side 18 of the shipping platform 12 thus permitting the shipping platform to be moved by a shipping platform mover (not shown). The covering 14 is non-destructively stored in the second position in a smaller area than in the first position. In other words, the covering 14 is not permanently damaged by the reduction in storage area.

In an embodiment, the shipping platform 12 comprises a pallet and/or the like. In another embodiment, the shipping platform mover comprises a pallet jack, forklift, front loader, and/or the like.

In an embodiment, the covering 14 is carried by a shipping platform storage rack 38 in which the shipping platform 12 is positioned. In another embodiment, the covering 14 is retractable into a housing 40 carried by the shipping platform storage rack.

In an embodiment, the housing 40 includes within it a biasing mechanism (not shown) that tensions the covering 14 in the first position and returns the covering into the housing in the second position. In another embodiment, the covering 14 carries a connector 42 on the end opposite the biasing mechanism to engage the shipping platform storage rack 38. In another embodiment, the housing 40 carries a second connector 44 for engaging the shipping platform storage rack 38 in a different area of the shipping platform storage rack than the first connector 42.

In an embodiment, the covering 14 comprises a textile and/or a monolithic substance such as plastic and/or the like. In another embodiment, the covering 14 comprise information 20 carried by the covering that is directed to the consumer.

In an embodiment, the covering material 14 substantially covers the side 18 of the shipping platform 12. In another embodiment, the information 20 is removable from the covering 14. In another embodiment, the covering material 14 is positioned in front of the side 18 of the shipping platform 12 and below any load 36 carried by the shipping platform.

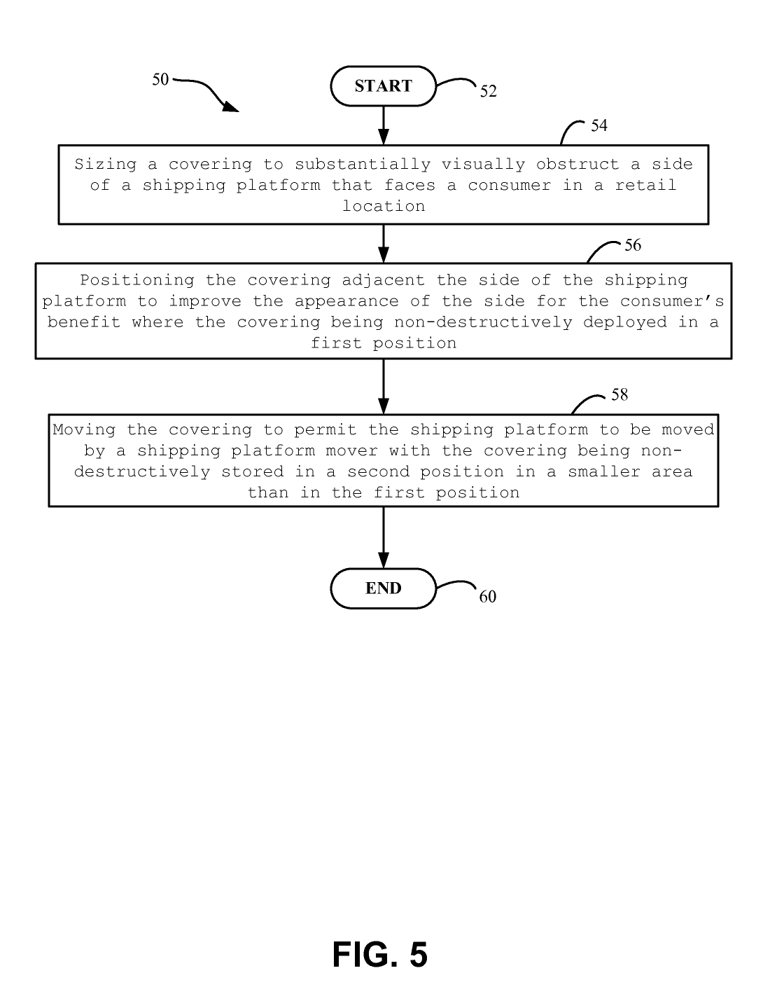

Another aspect of the invention is a method for a shipping platform display system which is now described with reference to flowchart 50 of FIG. 5. The method begins at Block 52 and may include sizing a covering to substantially visually obstruct a side of a shipping platform that faces a consumer in a retail location at Block 54. The method may also include positioning the covering adjacent the side of the shipping platform to improve the appearance of the side for the consumer's benefit where the covering being non-destructively deployed in a first position at Block 56. The method may further include moving the covering to permit the shipping platform to be moved by a shipping platform mover with the covering being non-destructively stored in a second position in a smaller area than in the first position at Block 58. The method ends at Block 60.

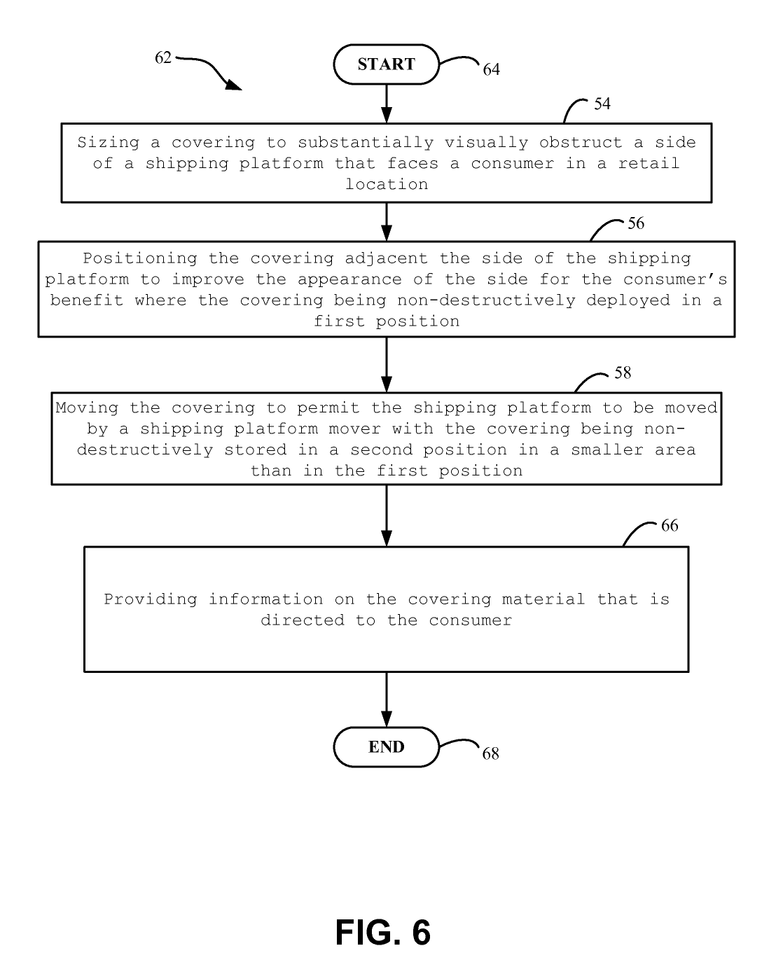

In another method embodiment, which is now described with reference to flowchart 62 of FIG. 6, the method begins at Block 64. The method may include the steps of FIG. 5 at Blocks 54, 56, and 58. The method may further include providing information on the covering material that is directed to the consumer at Block 66. The method ends at Block 68.

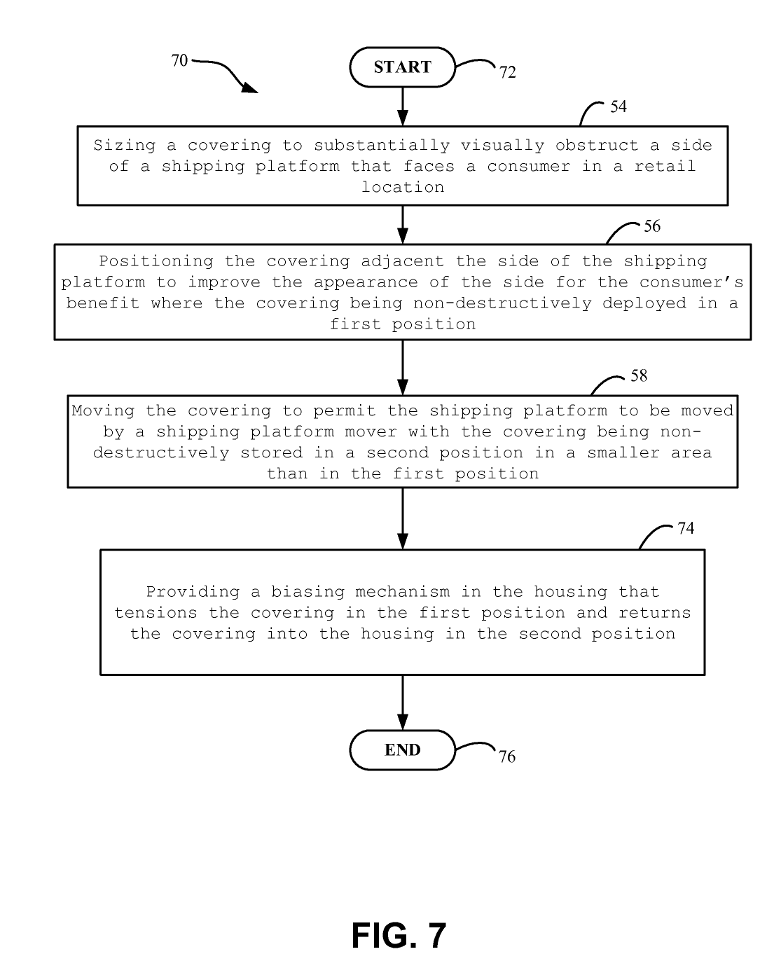

In another method embodiment, which is now described with reference to flowchart 70 of FIG. 7, the method begins at Block 72. The method may include the steps of FIG. 5 at Blocks 54, 56, and 58. The method may further include providing a biasing mechanism in the housing that tensions the covering in the first position and returns the covering into the housing in the second position at Block 74. The method ends at Block 76.

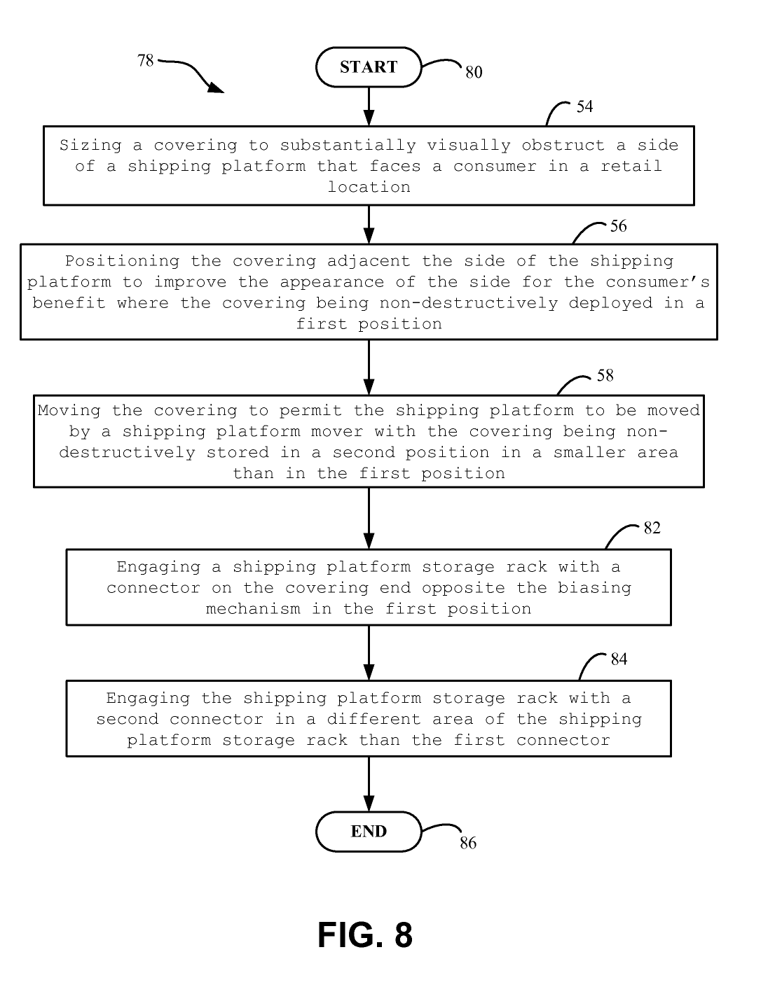

In another method embodiment, which is now described with reference to flowchart 78 of FIG. 8, the method begins at Block 80. The method may include the steps of FIG. 5 at Blocks 54, 56, and 58. The method may further include engaging a shipping platform storage rack with a connector on the covering end opposite the biasing mechanism in the first position at Block 82. The method may additionally include engaging the shipping platform storage rack with a second connector in a different area of the shipping platform storage rack than the first connector at block 84. The method ends at Block 86.

In view of the foregoing, the system 10 provides information 20 to an observer, e.g. customer, as well increases appeal of the load 36, e.g. the products, merchandise, and/or the like, carried by the shipping platform 12 as consumers may associate the condition, value, and/or need for a product with its surroundings. In other words, the presentation of a product 36 creates an influence on the potential purchaser that may be positive or negative. As a result, the shipping platform 12 on which the merchandise 36 is displayed in and/or on may impact how much product a retailer sells. Another issue is that all space within a retailer is generally highly valued. Stated another way, wasted space is a wasted opportunity to sell product and therefore using system 10 enables a retailer to provide information 20 in an otherwise unused area of their store.

It should be noted that in some alternative implementations, the functions noted in a flowchart block may occur out of the order noted in the figures. For instance, two blocks shown in succession may, in fact, be executed substantially concurrently, or the blocks may sometimes be executed in the reverse order, depending upon the functionality involved because the flow diagrams depicted herein are just examples. There may be many variations to these diagrams or the steps (or operations) described therein without departing from the spirit of the invention. For example, the steps may be performed concurrently and/or in a different order, or steps may be added, deleted, and/or modified. All of these variations are considered a part of the claimed invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A system comprising:
a covering adjacent a shipping platform;
a first position where the covering obstructs a side of the shipping platform to improve the shipping platform's appearance for a consumer, the covering being non-destructively deployed in the first position; and
a second position where the covering does not obstruct the side of the shipping platform to permit the shipping platform to be moved by a shipping platform mover, the covering being non-destructively stored in the second position in a smaller area than in the first position.

2. The system of claim 1 wherein the covering is carried by a shipping platform storage rack in which the shipping platform is positioned.

3. The system of claim 2 wherein the covering is retractable into a housing carried by the shipping platform storage rack.

4. The system of claim 3 wherein the housing includes a biasing mechanism that tensions the covering in the first position and returns the covering into the housing in the second position.

5. The system of claim 4 wherein the covering carries a connector on the end opposite the biasing mechanism to engage the shipping platform storage rack.

6. The system of claim 5 wherein the housing carries a second connector for engaging the shipping platform storage rack in a different area of the shipping platform storage rack than the first connector.

7. The system of claim 1 wherein the covering comprises at least one of a textile and a monolithic substance.

8. The system of claim 1 wherein the covering comprises information carried by the covering that is directed to the consumer.

9. A method comprising:
sizing a covering to substantially visually obstruct a side of a shipping platform that faces a consumer in a retail location;
positioning the covering adjacent the side of the shipping platform to at least one of improve the appearance of the side and relay information for the consumer's benefit, the covering being non-destructively deployed in a first position; and
moving the covering to permit the shipping platform to be moved by a shipping platform mover with the covering being non-destructively stored in a second position in a smaller area than in the first position.

10. The method of claim 9 further including providing information on the covering material that is directed to the consumer.

11. The method of claim 9 wherein the moving is done without at least one of tools, damage to the covering material, and permanent deformation to the covering material.

12. The method of claim 9 further comprising providing a biasing mechanism in the housing that tensions the covering in the first position and returns the covering into the housing in the second position.

13. The method of claim 12 further comprising engaging a shipping platform storage rack with a connector on the covering end opposite the biasing mechanism in the first position.

14. The method of claim 13 further comprising engaging the shipping platform storage rack with a second connector in a different area of the shipping platform storage rack than the first connector.

15. A system comprising:
a covering adjacent a shipping platform and carried by a shipping platform storage rack in which the shipping platform is positioned;
a first position where the covering obstructs a side of the shipping platform to at least one of improve the shipping platform's appearance and relay information to a consumer, the covering being non-destructively deployed in the first position; and
a second position where the covering does not obstruct the side of the shipping platform to permit the shipping platform to be moved by a shipping platform mover, the covering being non-destructively stored in the second position in a smaller area than in the first position.

16. The system of claim 15 wherein the covering is retractable into a housing carried by the shipping platform storage rack.

17. The system of claim 16 wherein the housing includes a biasing mechanism that tensions the covering in the first position and returns the covering into the housing in the second position.

18. The system of claim 17 wherein the covering carries a connector on the end opposite the biasing mechanism to engage the shipping platform storage rack.

19. The system of claim 18 wherein the housing carries a second connector for engaging the shipping platform storage rack in a different area of the shipping platform storage rack than the first connector.

20. The system of claim 15 wherein the covering comprises at least one of a textile and a monolithic substance.
